(19) United States
(12) Patent Application Publication
(10) Pub. No.: US 2024/0056313 A1
(43) Pub. Date: Feb. 15, 2024

(54) SELECTING A DATA CONNECTION BASED ON DIGITAL CERTIFICATE INFORMATION

(71) Applicant: Lenovo (Singapore) Pte. Ltd., New Tech Park (SG)

(72) Inventors: Apostolis Salkintzis, Athens (GR); Andreas Kunz, Ladenburg (DE); Roozbeh Atarius, La Jolla, CA (US); Dimitrios Karampatsis, Ruislip (GB)

(21) Appl. No.: 18/260,453

(22) PCT Filed: Jan. 5, 2021
(86) PCT No.: PCT/EP2021/050099

§ 371 Date: Jul. 5, 2023

(51) Int. Cl. H04L 9/32; H04L 9/40

(52) U.S. Cl. CPC H04L 9/3263; H04L 63/20

(57) ABSTRACT

Apparatuses, methods, and systems are disclosed for selecting a data connection based on digital certificate information. One apparatus includes a transceiver and a processor that receives a request to send a data packet and determines a first application identity used by a first application. The processor finds a first policy rule in the apparatus that matches the first application identity and determines whether the first application matches a digital certificate information. Here, the first policy rule contains the digital certificate information. Upon determining that the first application matches the digital certificate information, the processor applies the first policy rule to select a first set of data connection parameters and the transceiver transmits the data packet via a data connection using the first set of data connection parameters.

### FIELD

The subject matter disclosed herein relates generally to wireless communications and more particularly relates to selecting a data connection based on digital certificate information.

### BACKGROUND

The following abbreviations are herewith defined, at least some of which are referred to within the following description: Third Generation Partnership Project (“3GPP”), Fifth Generation System (“5GS”), Authentication, Authorization and Accounting (“AAA”), Application Function (“AF”), Automated Guided Vehicle (“AGV”), Access and Mobility Management Function (“AMF”), Anti-Money Laundering (“AML”), Positive-Acknowledgment (“ACK”), Application Programming Interface (“API”), Access Stratum (“AS”), Application Service Provider (“ASP”), Base Station (“BS”), Core Network (“CN”), Control Plane (“CP”), Data Network (“DN”), Decentralized Identifier (“DID”), Digital Identifier (“DIG-ID”), Downlink (“DL”), Distributed Ledger Technology (“DLT”), DN Name (“DNN”), Distributed Transaction Verification Network (“DTVN”), Edge Application Server (“EAS”), Edge Computing Service Provider (“ECSP”), Edge Data Network (“EDN”), Edge Enabler Client (“EEC”), Edge Enabler Server (“EES”), Evolved Node-B (“eNB”), Evolved Packet Core (“EPC”), Factory of the Future (“FF”), FF Application Enabler (“FAE”), FAE Client (“FAE-C”), FAE Server (“FAE-S”), Fully Qualified Domain Name (“FQDN”, also referred to as an “absolute domain name”), New Generation (i.e., 5G) Node-B (“gNB”), General Packet Radio Service (“GPRS”), Generic Public Service Identifier (“GPSI”), Global System for Mobile Communications (“GSM”), Home Subscriber Server (“HSS”), Internet-of-Things (“IoT”), Identity Management (“IM”), Know Your Customer (“KYM”), Long Term Evolution (“LTE”), Mobile Edge Computing (“MEC”), Massive IoT (“mIoT”), Mobility Management Entity (“MME”), Mobile Network Operator (“MNO”), Negative-Acknowledgment (“NACK”) or (“NAK”), New Radio (“NR”, a 5G radio access technology; also referred to as “5G NR”), Non-Access Stratum (“NAS”), Non-Public Network (“NPN”), Network Slice Selection Assistance Information (“NSSAI”), Original Equipment Manufacturer (“OEM”), Operating System Identifier (“OSid”), Over-the-Air (“OTA”), Packet Data Unit (“PDU”, used in connection with ‘PDU Session’), Partially Qualified Domain Name (“PQDN”, also referred to as a “relative domain name”), Policy Control Function (“PCF”), Public Land Mobile Network (“PLMN”), Quality of Experience (“QoE”), Quality of Service (“QoS”), Radio Access Network (“RAN”), Service Enabler Architecture Layer (“SEAL”), Session Management Function (“SMF”), Service Provider (“SP”), Single Network Slice Selection Assistance Information (“S-NSSAI”), Self-Sovereign Identity (“SSI”), Subscription Concealed Identifier (“SUCI”), Subscription Permanent Identifier (“SUN”), Time Sensitive Networking (“TSN”), Trust Service Provider (“TSP”), Vehicle-to-Everything (“V2X”), Vehicle-to-Infrastructure (“V2I”), Vehicle-to-Vehicle (“V2V”), V2X Application Enabler (“VAE”), VAE Client (“VAE-C”), VAE Server (“VAE-S”), Unified Data Management (“UDM”), User Data Repository (“UDR”), User Entity/Equipment (Mobile Terminal) (“UE”), Uplink (“UL”), User Plane (“UP”), User Plane Function (“UPF”), Universal Mobile Telecommunications System (“UMTS”), Vertical Application Layer (“VAL”), and Worldwide Interoperability for Microwave Access (“WiMAX”).

A user equipment (“UE”) may have a plurality of UE Route Selection Policy (“URSP”) rules, each one containing a traffic descriptor component and a route selection descriptor component. The route selection descriptor component identifies the data connection that must be used to transmit the traffic that matches the traffic descriptor component.

### BRIEF SUMMARY

Disclosed are procedures for selecting a data connection based on digital certificate information. One method of a UE for selecting a data connection based on digital certificate information includes receiving a request to send a data packet and determining a first application identity used by a first application. The first method includes finding a first policy rule in the UE that matches the first application identity, the first policy rule containing digital certificate information, and determining whether the first application matches the digital certificate information. The first method includes applying the first policy rule to select a first set of data connection parameters, in response to determining that the first application matches the digital certificate information and transmitting the data packet via a data connection using the first set of data connection parameters.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for selecting a data connection based on digital certificate information;

FIG. 2 is a diagram illustrating one embodiment of a procedure for a network architecture and signaling flow for selecting a data connection based on digital certificate information;

FIG. 3A is a diagram illustrating signaling flow for one embodiment of a procedure for application signing;

FIG. 3B is a diagram illustrating signaling flow for one embodiment of a digital certificate;

FIG. 4 is a diagram illustrating one embodiment of a user equipment apparatus that may be used for selecting a data connection based on digital certificate information; and

FIG. 5 is a diagram illustrating one embodiment of a user equipment apparatus that may be used for selecting a data connection based on digital certificate information; and

FIG. 6 is a flowchart diagram illustrating one embodiment of a method that may be used for selecting a data connection based on digital certificate information.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of” A, B, and C and combinations thereof includes only A, only B, only C, a combination of A and B, a combination of B and C, a combination of A and C or a combination of A, B and C.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatus for selecting a data connection based on digital certificate information. Disclosed herein are mechanisms/techniques to extend the traffic descriptor component of a UE Route Selection Policy (“URSP”) rule is extended to also contain digital certificate information.

As specified in TS 23.502, a 5G-capable UE may have a plurality of URSP rules, each one containing a traffic descriptor component and a route selection descriptor component. In one embodiment, a URSP rule can map the traffic generated by a first application into a data connection utilizing a first set of data connection parameters. To identify the traffic generated by the first application, the traffic descriptor component of the URSP rule comprises the identity of the first application.

Note, however, that the identity of an application is not a secure identifier, i.e., it cannot uniquely identify an application. Thus, it is feasible that a second application is (maliciously) designed to have the same identifier as the identifier of a first application. This way, the second application pretends to be the first application and can cause the UE to transmit its traffic based on a URSP rule that was designed to be applied for the traffic of the first application.

To overcome this issue, this disclosure introduces changes to the URSP rules and to the procedures applied by the UE. In particular, the traffic descriptor component of a URSP rule is extended to also contain digital certificate information. In one embodiment, the digital certificate information contains information that uniquely identifies a digital certificate, e.g., a certificate fingerprint. The UE applies a URSP rule for the traffic of an application only when this application is signed with the certificate identified by the digital certificate information in the URSP rule. Current 3GPP specifications do not define a URSP rule with digital certificate information and do not define how the UE applies a URSP rule that contains an application identity and digital certificate information.

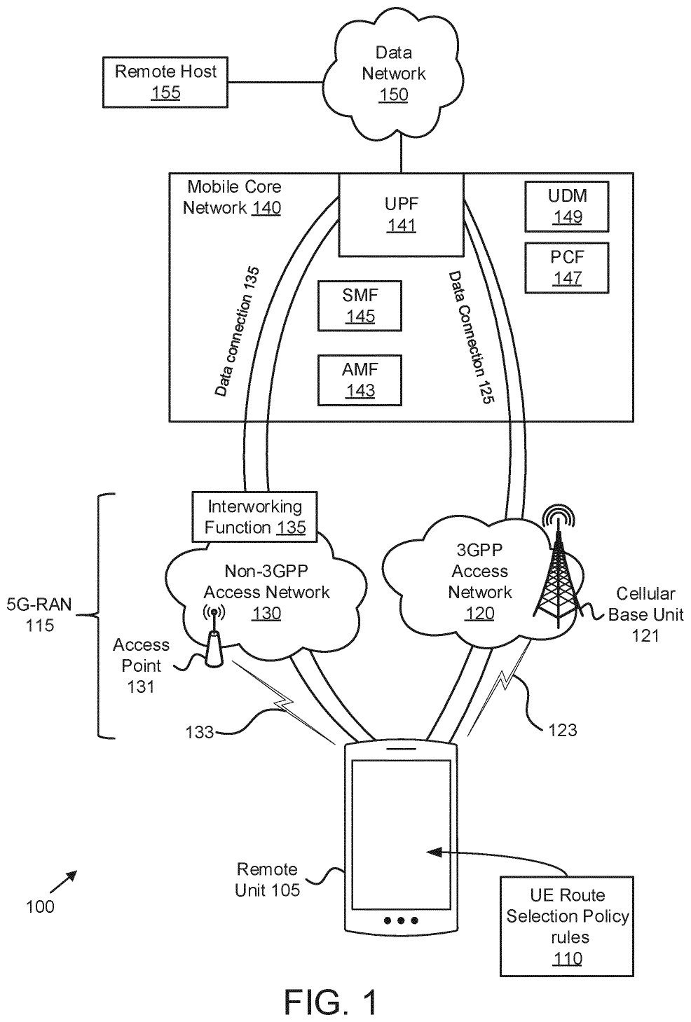

FIG. 1 depicts a wireless communication system 100 for measuring RTT, according to embodiments of the disclosure. In one embodiment, the wireless communication system 100 includes at least one remote unit 105, a 5G-RAN 115, and a mobile core network 140. The 5G-RAN 115 and the mobile core network 140 form a mobile communication network. The 5G-RAN 115 may be composed of a 3GPP access network 120 containing at least one cellular base unit 121 and/or a non-3GPP access network 130 containing at least one access point 131. The remote unit communicates with the 3GPP access network 120 using 3GPP communication links 123 and communicates with the non-3GPP access network 130 using non-3GPP communication links 133. Even though a specific number of remote units 105, 3GPP access networks 120, cellular base units 121, 3GPP communication links 123, non-3GPP access networks 130, access points 131, non-3GPP communication links 133, and mobile core networks 140 are depicted in FIG. 1, one of skill in the art will recognize that any number of remote units 105, 3GPP access networks 120, cellular base units 121, 3GPP communication links 123, non-3GPP access networks 130, access points 131, non-3GPP communication links 133, and mobile core networks 140 may be included in the wireless communication system 100.

In one implementation, the wireless communication system 100 is compliant with the 5G system specified in the 3GPP specifications. More generally, however, the wireless communication system 100 may implement some other open or proprietary communication network, for example, LTE or WiMAX, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as UEs, subscriber units, mobiles, mobile stations, users, terminals, mobile terminals, fixed terminals, subscriber stations, user terminals, wireless transmit/receive unit (“WTRU”), a device, or by other terminology used in the art.

The remote units 105 may communicate directly with one or more of the cellular base units 121 in the 3GPP access network 120 via uplink (“UL”) and downlink (“DL”) communication signals. Furthermore, the UL and DL communication signals may be carried over the 3GPP communication links 123. Similarly, the remote units 105 may communicate with one or more access points 131 in the non-3GPP access network(s) 130 via UL and DL communication signals carried over the non-3GPP communication links 133. Here, the access networks 120 and 130 are intermediate networks that provide the remote units 105 with access to the mobile core network 140.

A remote unit 105 may have multiple network interfaces, each one using either a 3GPP access (e.g., 5G radio access) or a non-3GPP access (e.g., WLAN radio access, satellite radio access, etc.). A remote unit 105 transfers data traffic via a network connection between the remote unit 105 and the mobile core network 140, such as a PDU session, which is established either over 3GPP access or non-3GPP access. A PDU session which is established over both 3GPP access and non-3GPP access is referred to as a “multi-access” PDU session. In some embodiments, the remote unit 105 may offload data traffic directly over a non-3GPP access network, e.g., to a local server instance.

In some embodiments, the remote units 105 communicate with a remote host 155 via a network connection with the mobile core network 140. For example, a mobile application (e.g., web browser, media client, telephone/VoIP application, mobile application client 109) in the remote unit 105 may trigger the remote unit 105 to establish a PDU session (or other data connection) with the mobile core network 140 using the 5G-RAN 115 (e.g., a 3GPP access network 120 and/or a non-3GPP access network 130). The mobile core network 140 then relays traffic between the remote unit 105 and the data network 150 (e.g., remote host 155) using the PDU session. The PDU session represents a logical connection between the remote unit 105 and the UPF 141. In order to establish the PDU session, the remote unit 105 must be registered with the mobile core network.

Each PDU session is essentially a virtual data connection between the UE and the mobile communication network that is explicitly established by the UE. The PDU session has certain attributes negotiated by the UE and the mobile communication network when the PDU session is established. These attributes remain the same throughout the lifetime of the PDU session. A PDU session may be established via 3GPP access or via non-3GPP access.

Note that the remote unit 105 may establish one or more PDU sessions (or other data connections) with the mobile core network 140. As such, the remote unit 105 may have at least one PDU session for communicating with the data network 150. The remote unit 105 may establish additional PDU sessions for communicating with other data network and/or other remote hosts. In various embodiments, the remote unit 105 may be configured with UE Route Selection Policy rules 110 for directing traffic of a mobile application to a specific PDU session.

The cellular base units 121 may be distributed over a geographic region. In certain embodiments, a cellular base unit 121 may also be referred to as an access terminal, a base, a base station, a Node-B, an eNB, a gNB, a Home Node-B, a relay node, a device, or by any other terminology used in the art. The cellular base units 121 are generally part of a radio access network (“RAN”), such as the 3GPP access network 120, that may include one or more controllers communicably coupled to one or more corresponding cellular base units 121. These and other elements of radio access network are not illustrated but are well known generally by those having ordinary skill in the art. The cellular base units 121 connect to the mobile core network 140 via the 3GPP access network 120.

The cellular base units 121 may serve a number of remote units 105 within a serving area, for example, a cell or a cell sector, via a 3GPP communication link 123. The cellular base units 121 may communicate directly with one or more of the remote units 105 via communication signals. Generally, the cellular base units 121 transmit DL communication signals to serve the remote units 105 in the time, frequency, and/or spatial domain. Furthermore, the DL communication signals may be carried over the 3GPP communication links 123. The 3GPP communication links 123 may be any suitable carrier in licensed or unlicensed radio spectrum. The 3GPP communication links 123 facilitate communication between one or more of the remote units 105 and/or one or more of the cellular base units 121.

The non-3GPP access networks 130 may be distributed over a geographic region. Each non-3GPP access network 130 may serve a number of remote units 105 with a serving area. An access point 131 in a non-3GPP access network 130 may communicate directly with one or more remote units 105 by receiving UL communication signals and transmitting DL communication signals to serve the remote units 105 in the time, frequency, and/or spatial domain. Both DL and UL communication signals are carried over the non-3GPP communication links 133. The 3GPP communication links 123 and non-3GPP communication links 133 may employ different frequencies and/or different communication protocols. In various embodiments, an access point 131 may communicate using unlicensed radio spectrum. The mobile core network 140 may provide services to a remote unit 105 via the non-3GPP access networks 130, as described in greater detail herein.

In some embodiments, a non-3GPP access network 130 connects to the mobile core network 140 via an interworking function 135. The interworking function 135 provides interworking between the remote unit 105 and the mobile core network 140. In some embodiments, the interworking function 135 is a Non-3GPP Interworking Function (“N3IWF”) and, in other embodiments, it is a Trusted Non-3GPP Gateway Function (“TNGF”). The N3IWF supports the connection of “untrusted” non-3GPP access networks to the mobile core network (e.g., 5GC), whereas the TNGF supports the connection of “trusted” non-3GPP access networks to the mobile core network. The interworking function 135 supports connectivity to the mobile core network 140 via the “N2” and “N3” interfaces, and it relays “N1” signaling between the remote unit 105 and the AMF 143. Both the 3GPP access network 120 and the interworking function 135 communicate with the AMF 143 using a “N2” interface. The interworking function 135 also communicates with the UPF 141 using a “N3” interface.

In certain embodiments, a non-3GPP access network 130 may be controlled by an operator of the mobile core network 140 and may have direct access to the mobile core network 140. Such a non-3GPP AN deployment is referred to as a “trusted non-3GPP access network.” A non-3GPP access network 130 is considered as “trusted” when it is operated by the 3GPP operator, or a trusted partner, and supports certain security features, such as strong air-interface encryption. In contrast, a non-3GPP AN deployment that is not controlled by an operator (or trusted partner) of the mobile core network 140, does not have direct access to the mobile core network 140, or does not support the certain security features is referred to as a “non-trusted” non-3GPP access network.

In one embodiment, the mobile core network 140 is a 5G core (“5GC”) or the evolved packet core (“EPC”), which may be coupled to a data network (e.g., the data network 150, such as the Internet and private data networks, among other data networks. A remote unit 105 may have a subscription or other account with the mobile core network 140. Each mobile core network 140 belongs to a single public land mobile network (“PLMN”). The present disclosure is not intended to be limited to the implementation of any particular wireless communication system architecture or protocol.

The mobile core network 140 includes several network functions (“NFs”). As depicted, the mobile core network 140 includes at least a UPF 141 that serves the 3GPP access network 120 and the non-3GPP access network 130. Note that in certain embodiments, the mobile core network may contain one or more intermediate UPFs, for example a first intermediate UPF that serves the non-3GPP access network 130 and the second intermediate UPF that serves the 3GPP access network 120. In such embodiments, the UPF 141 would be an anchor UPF receiving UP traffic of both intermediate UPFs.

The mobile core network 140 also includes multiple control plane functions including, but not limited to, an Access and Mobility Management Function (“AMF”) 143 that serves both the 3GPP access network 120 and the non-3GPP access network 130, a Session Management Function (“SMF”) 145, a Policy Control Function (“PCF”) 147, and a Unified Data Management function (“UDM”) 149. In certain embodiments, the mobile core network 140 may also include an Authentication Server Function (“AUSF”), a Network Repository Function (“NRF”) (used by the various NFs to discover and communicate with each other over APIs), or other NFs defined for the 5GC.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. Each slice may be identified using a S-NSSAI. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

Although specific numbers and types of network functions are depicted in FIG. 1, one of skill in the art will recognize that any number and type of network functions may be included in the mobile core network 140. Moreover, where the mobile core network 140 is an EPC, the depicted network functions may be replaced with appropriate EPC entities, such as an MME, S-GW, P-GW, HSS, and the like.

As depicted, a remote unit 105 (e.g., a UE) may connect to the mobile core network (e.g., to a 5G mobile communication network) via two types of accesses: (1) via 3GPP access network 120 and (2) via a non-3GPP access network 130. The first type of access (e.g., 3GPP access network 120) uses a 3GPP-defined type of wireless communication (e.g., NG-RAN) and the second type of access (e.g., non-3GPP access network 130) uses a non-3GPP-defined type of wireless communication (e.g., WLAN). The 5G-RAN 115 refers to any type of 5G access network that can provide access to the mobile core network 140, including the 3GPP access network 120 and the non-3GPP access network 130.

As discussed above, a 5G-capable UE may have a plurality of URSP rules, each one containing a traffic descriptor component and a route selection descriptor component. The route selection descriptor component identifies the data connection that must be used to transmit the traffic that matches the traffic descriptor component. A data connection is identified with a set of data connection parameters, wherein a data connection parameter can identify (a) the name of the external data network (e.g., Data Network Name) reachable via the data connection, (b) a network slice utilized by the data connection (e.g., identified by a S-NSSAI), (c) the radio access network type utilized by the data connection (e.g., 3GPP access or non-3GPP access), (d) the IP type utilized by the data connection (e.g., IPv4 or IPv6), (e) the session and service continuity type (“SSC type”) provided by the data connection, etc.

While FIG. 1 depicts components of a 5G RAN and a 5G core network, the described solutions apply to other types of communication networks and RATs, including IEEE 802.11 variants, GSM, GPRS, UMTS, LTE variants, CDMA 2000, Bluetooth, ZigBee, Sigfoxx, and the like. For example, in an LTE variant involving an EPC, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc. Thus, while the operations are described mainly in the context of 5G systems, the proposed solutions/methods are also equally applicable to other mobile communication systems supporting a data connection selection based on digital certificate information.

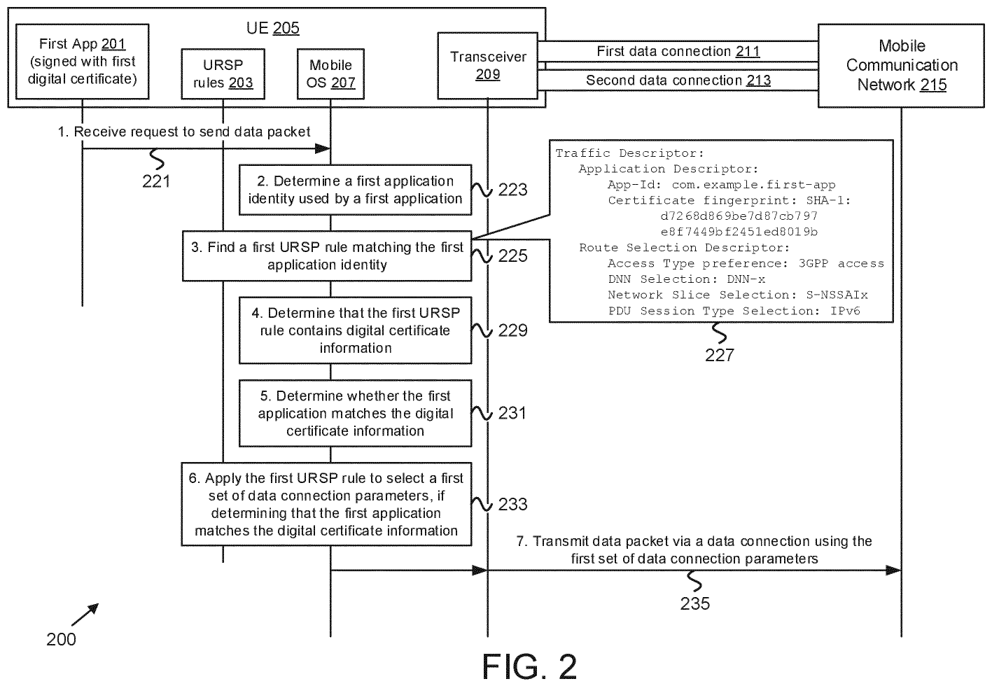

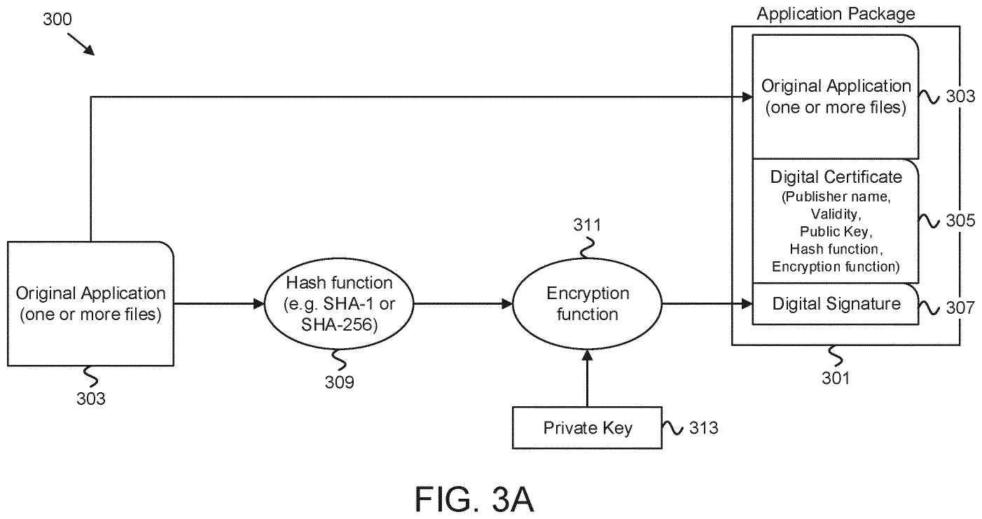

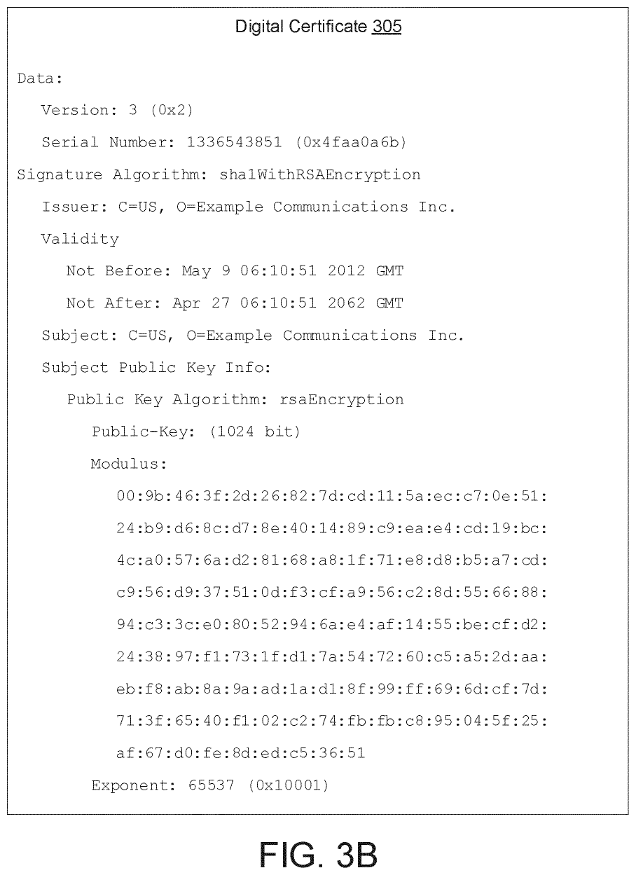

FIG. 2 depicts a procedure 200 for selecting a data connection based on digital certificate information. The procedure 200 is implemented by a UE 205 that contains a first application 201 signed with a first digital certificate. This means that the first application 201 is cryptographically signed with a private key that corresponds to the public key in the first digital certificate, and that the public key in the first digital certificate can be used to validate the authenticity of the first application 201. Examples of application signing and digital certificates are discussed below with reference to FIGS. 3A-3B. In various embodiments, each UE application is signed with a unique digital certificate.

The UE 205 is configured with a set of one or more URSP rules 203, each one containing a traffic descriptor component and a route selection descriptor component (as per TS 23.503). The route selection descriptor component indicates the data connection parameters that must be used to transmit the traffic that matches the traffic descriptor component. Essentially, the URSP rules 203 map the different traffic flows generated in the UE 205 into different data connections, each one utilizing different data connection parameters.

The UE 205 communicates with a mobile communication network 215 (e.g., 5G network) comprising a radio access network (e.g., 5G-RAN) and a core network (e.g., 5G core network). The radio access network can comprise multiple types of radio access networks, e.g., 3GPP access network and non-3GPP access network.

The mobile communication network 215 supports a plurality of data connections (PDU Sessions), each data connection utilizing a set of data connection parameters. A data connection parameter can identify (a) the name of the external data network (Data Network Name, DNN) reachable via the data connection, such as the data network 150, (b) a network slice utilized by the data connection (S-NSSAI), (c) the radio access network type utilized by the data connection (3GPP access or non-3GPP access), (d) the IP type utilized by the data connection (e.g. IPv4 or IPv6), (e) the session and service continuity type (SSC type) provided by the data connection, etc. For example, the data connection 125 utilizes a 3GPP access network type, whereas the data connection 135 utilizes a non-3GPP access network type.

The UE may have one or multiple data connections with the mobile communication network. In the depicted embodiment, the UE 205 includes a radio transceiver 209 that supports at least a first connection 211 to a mobile communication network 215 and a second connection 213 to the network 215.

The procedure 200 begins at Step 1 as the mobile OS 207 in the UE 205 receives a request to send a data packet. Although we consider the mobile OS 207 receiving the request, in alternative embodiments, a component outside the mobile OS 207 may receive this request, e.g., another application in the UE 205 or a component in a modem of the UE 205.

At Step 2, the mobile OS 207 determines a first application identity used by the first application 201, i.e., determines the identity of the application that sent the request, e.g., “com.example.first-app”.

At Step 3, the mobile OS 207 finds a first URSP rule 303 in the UE 205 matching the first application identity. This URSP rule may be referred to as a “candidate URSP rule” and/or a “matching URSP rules.” One example URSP rule 227 is depicted. The example URSP rule 227 matches the first application identity because it contains a traffic descriptor with an application identity equal to the first application identity “com.example.first-app.”

At Step 4, the mobile OS 207 determines that the first URSP rule contains digital certificate information, e.g., a certificate fingerprint. A certificate fingerprint consists of a value that uniquely identifies a digital certificate and the hash function used to generate this value. For example,
Certificate fingerprint=SHA-1(contents of a digital certificate),
   where SHA-1 is the hash function.

In the example URSP rule 227, the digital certificate information is contained in the traffic descriptor component of the URSP rule 227 and consists of a certificate fingerprint. In other embodiments, the matching URSP rule can contain other types of digital certificate information, e.g., the publisher name.

Note that the URSP rules 303 are generated by the mobile communication network 215 and sent to the UE 205. In some embodiments, the mobile communication network includes functionality to extract the digital certificate from an application package and create the digital certificate information, such as the certificate fingerprint. In other embodiments, the mobile communication network 215 includes at least one interface where an external application function can send to the network 215 the digital certificate information associated with an application. The external application function may send to the network 215 digital certificate information for multiple applications.

At Step 5, the mobile OS 207 determines whether the first application 201 matches the digital certificate information. For example, when the digital certificate information contains a certificate fingerprint (e.g., ‘SHA-1: d7268d869be7d87cb797e8f7449bf2451ed8019b’), the mobile OS 207 uses the hash function in this fingerprint (e.g., SHA-1) and the contents of the first digital certificate to generate a hash value. If this hash value is equal to the certificate fingerprint value in the URSP rule (e.g., ‘d7268d869be7d87cb797e8f7449bf2451ed8019b’), then the first application 201 matches the digital certificate information.

When the digital certificate information contains a publisher name, the first application 201 matches the digital certificate information, when publisher name in the matching URSP rule is the same with the publisher name in the first digital certificate.

At Step 6, the mobile OS 207 applies the first URSP rule to select a first set of data connection parameters, if determining that the first application matches the digital certificate information. When the mobile OS 207 applies the matching URSP rule, it selects the data connection parameters (access type, DNN, etc.) in the route selection descriptor of the matching URSP rule. If the first application 201 does not match the digital certificate information in the URSP rule matching the first application identity, then the URSP rule is not applied and the UE 205 attempts find another URSP rule that matches the first application identity (i.e., step 3 is executed again).

At Step 7, the mobile OS 207 transmits the data packet via a data connection using the first set of data connection parameters.

FIG. 3A depicts one example of a procedure 300 for application signing. An application package 301 contains the original application 303 (i.e., one or more files) and further contains a digital certificate 305 and a digital signature 307. Before the original application 303 is published (e.g., to a mobile marketplace), it is cryptographically signed by using the private key 313 of the publisher, which is a unique key only known by the publisher.

The generated digital signature 307 and the digital certificate 305 that can be used to validate the authenticity of the application file(s) 303 are both included in the application package 301, which can be published and distributed. In the depicted embodiment, the original application file(s) 303 are run through a cryptographic hash function 309 (e.g., SHA-1, SHA-256, or another suitable algorithm). The hash value that is output by the cryptographic hash function 309 is then encrypted into the digital signature 307 by an encryption function 311 using the private key 313 of the publisher. Note that the private key 313 is one of a public-private key pair, with the corresponding public key being included in the digital certificate 305. One example of a digital certificate is discussed below with reference to FIG. 3B.

When an application is downloaded in a UE, the mobile OS in the UE uses the public key and the cryptographic algorithms contained in the embedded digital certificate to validate the authenticity of the application, i.e., to confirm that the application was signed by the corresponding private key that only the publisher knows. If this validation is successful, then the UE knows that the application is authentic, i.e., it has not been modified in any way. It also knows the name of the application publisher.

FIG. 3B depicts one example of the digital certificate 305, according to embodiments of the disclosure. Note that every UE application may be signed with a unique digital certificate 305, which typically contains a validity period, the publisher of the application, the public key of the publisher, etc. In the example digital certificate 305, the Issuer is “Example Communication Inc.” The digital certificate 305 contains the Modulus and the Exponent that can be used to generate the public key, the publisher name (Issuer), a validity period, the cryptographic algorithms applied for creating the digital signature (SHA1 with RSA encryption), etc.

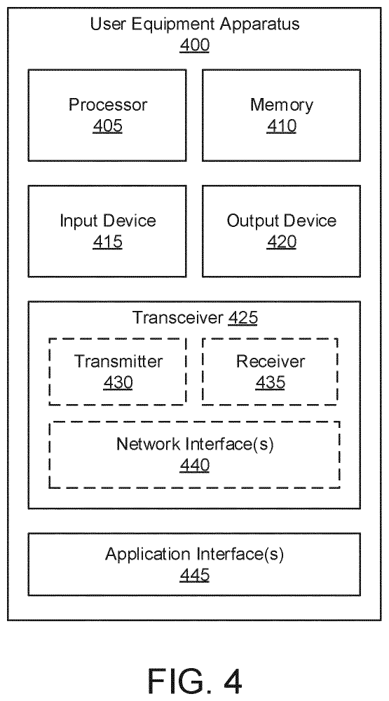

FIG. 4 depicts a user equipment apparatus 400 that may be used for selecting a data connection based on digital certificate information, according to embodiments of the disclosure. In various embodiments, the user equipment apparatus 400 is used to implement one or more of the solutions described above. The user equipment apparatus 400 may be implemented in a UE, such as the remote unit 105 and/or UE 205, described above. Furthermore, the user equipment apparatus 400 may include a processor 405, a memory 410, an input device 415, an output device 420, and a transceiver 425. In some embodiments, the input device 415 and the output device 420 are combined into a single device, such as a touchscreen. In certain embodiments, the user equipment apparatus 400 may not include any input device 415 and/or output device 420. In various embodiments, the user equipment apparatus 400 may include one or more of: the processor 405, the memory 410, and the transceiver 425, and may not include the input device 415 and/or the output device 420.

As depicted, the transceiver 425 includes at least one transmitter 430 and at least one receiver 435. Here, the transceiver 425 communicates with one or more remote units 105. Additionally, the transceiver 425 may support at least one network interface 440. In some embodiments, the transceiver 425 supports a first interface (e.g., Uu interface) for communicating with one or more base units in a RAN, a second interface (e.g., N1 interface) for communicating with an AMF, and a third interface for communicating with a TSN system.

The processor 405, in one embodiment, may include any known controller capable of executing computer-readable instructions and/or capable of performing logical operations. For example, the processor 405 may be a microcontroller, a microprocessor, a central processing unit (“CPU”), a graphics processing unit (“GPU”), an auxiliary processing unit, a FPGA, or similar programmable controller. In some embodiments, the processor 405 executes instructions stored in the memory 410 to perform the methods and routines described herein. The processor 405 is communicatively coupled to the memory 410, the input device 415, the output device 420, and the transceiver 425. In various embodiments, the processor 405 controls the user equipment apparatus 400 to implement the above described UE behaviors.

In various embodiments, the processor 405 controls the user equipment apparatus 400 to implement the above described UE behaviors. In some embodiments, the processor 405 receives a request (i.e., an internal request from an application running on the user equipment apparatus 400) to send a data packet and determines a first application identity used by a first application. The processor 405 finds a first policy rule in the user equipment apparatus 400 that matches the first application identity, the first policy rule containing digital certificate information and determines whether the first application matches the digital certificate information. Upon determining that the first application matches the digital certificate information, the processor 405 applies the first policy rule to select a first set of data connection parameters and transmits the data packet via a data connection using the first set of data connection parameters.

In some embodiments, the processor 405 determines the first application identity by determining an identity of the application that sent the request. In some embodiments, the user equipment apparatus 400 is configured with a plurality of policy rules by the mobile communication network. In some embodiments, the user equipment apparatus 400 contains a SIM (e.g., USIM), where the SIM contains a plurality of policy rules. In some embodiments, the policy rule is a URSP rule. In one embodiment, the SIM is pre-configured with the policy rules.

In some embodiments, the first policy rule matches the first application identity when the traffic descriptor of the first policy rule contains an application identity equal to the first application identity. In some embodiments, the first policy rule contains a traffic descriptor component comprising an application identity and the digital certificate information (e.g., as shown in the example URSP rule 227).

In some embodiments, the digital certificate information contains information (e.g., a certificate fingerprint) that uniquely identifies a digital certificate 305. In such embodiments, the information that uniquely identifies a digital certificate consists of a fingerprint value and a hash function utilized to generate the fingerprint value. In some embodiments, the digital certificate information contains information that identifies a publisher of the first application.

In some embodiments, the first application matches the digital certificate information if the digital certificate information in a traffic descriptor component of the first policy rule identifies a first digital certificate, where the first digital certificate is the certificate with which the first application is signed. In some embodiments, the first application matches the digital certificate information if the digital certificate information in a traffic descriptor component of the first policy rule contains information that is included in the first digital certificate, where the first digital certificate is the certificate with which the first application is signed.

In some embodiments, the processor 405 applies the first policy rule by selecting a set of data connection parameters contained in a route selection descriptor in this rule and applying these data connection parameters to transmit the data packet. In such embodiments, the processor 405 may determine whether a data connection that utilizes the first set of data connection parameters is already activated in the user equipment apparatus 400. If not already activated in the user equipment apparatus 400, the processor 405 activates a data connection that utilizes the first set of data connection parameters. The processor 405 controls the transceiver 425 to transmit the data packet via the activated data connection.

The user equipment apparatus 400 supports one or more application interfaces 445. Each application interface 445 supports communication among application instances running on the user equipment apparatus 400 and/or supports communication with an external application instance, e.g., running on a network device or a UE. In some embodiments, the application interface(s) 445 include a set of functions and procedures that allow for applications running on the user equipment apparatus 400 to access data and features of other applications, services, or operating systems.

The memory 410, in one embodiment, is a computer readable storage medium. In some embodiments, the memory 410 includes volatile computer storage media. For example, the memory 410 may include a RAM, including dynamic RAM (“DRAM”), synchronous dynamic RAM (“SDRAM”), and/or static RAM (“SRAM”). In some embodiments, the memory 410 includes non-volatile computer storage media. For example, the memory 410 may include a hard disk drive, a flash memory, or any other suitable non-volatile computer storage device. In some embodiments, the memory 410 includes both volatile and non-volatile computer storage media.

In some embodiments, the memory 410 stores data related to for selecting a data connection based on digital certificate information. For example, the memory 410 may store digital certificates, digital certificate information, URSP rules, and the like. In certain embodiments, the memory 410 also stores program code and related data, such as an operating system or other controller algorithms operating on the remote unit 105.

The input device 415, in one embodiment, may include any known computer input device including a touch panel, a button, a keyboard, a stylus, a microphone, or the like. In some embodiments, the input device 415 may be integrated with the output device 420, for example, as a touchscreen or similar touch-sensitive display. In some embodiments, the input device 415 includes a touchscreen such that text may be input using a virtual keyboard displayed on the touchscreen and/or by handwriting on the touchscreen. In some embodiments, the input device 415 includes two or more different devices, such as a keyboard and a touch panel.

The output device 420, in one embodiment, is designed to output visual, audible, and/or haptic signals. In some embodiments, the output device 420 includes an electronically controllable display or display device capable of outputting visual data to a user. For example, the output device 420 may include, but is not limited to, an LCD display, an LED display, an OLED display, a projector, or similar display device capable of outputting images, text, or the like to a user. As another, non-limiting, example, the output device 420 may include a wearable display separate from, but communicatively coupled to, the rest of the user equipment apparatus 400, such as a smart watch, smart glasses, a heads-up display, or the like. Further, the output device 420 may be a component of a smart phone, a personal digital assistant, a television, a table computer, a notebook (laptop) computer, a personal computer, a vehicle dashboard, or the like.

In certain embodiments, the output device 420 includes one or more speakers for producing sound. For example, the output device 420 may produce an audible alert or notification (e.g., a beep or chime). In some embodiments, the output device 420 includes one or more haptic devices for producing vibrations, motion, or other haptic feedback. In some embodiments, all or portions of the output device 420 may be integrated with the input device 415. For example, the input device 415 and output device 420 may form a touchscreen or similar touch-sensitive display. In other embodiments, the output device 420 may be located near the input device 415.

The transceiver 425 operates under the control of the processor 405 to transmit messages, data, and other signals and also to receive messages, data, and other signals. For example, the processor 405 may selectively activate the transceiver (or portions thereof) at particular times in order to send and receive messages.

In various embodiments, the transceiver 425 is configured to communicate with 3GPP access network(s) and/or the non-3GPP access network(s). In some embodiments, the transceiver 425 implements modem functionality for the 3GPP access network(s) and/or the non-3GPP access network(s). In one embodiment, the transceiver 425 implements multiple logical transceivers using different communication protocols or protocol stacks, while using common physical hardware.

In one embodiment, the transceiver 425 includes a first transmitter/receiver pair used to communicate with a mobile communication network over licensed radio spectrum and a second transmitter/receiver pair used to communicate with a mobile communication network over unlicensed radio spectrum. In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 425, transmitters 430, and receivers 435 may be implemented as physically separate components that access a shared hardware resource and/or software resource, such as for example, the network interface 440.

The transceiver 425 may include one or more transmitters 430 and one or more receivers 435. Although a specific number of transmitters 430 and receivers 435 are illustrated, the user equipment apparatus 400 may have any suitable number of transmitters 430 and receivers 435. Further, the transmitter(s) 430 and the receiver(s) 435 may be any suitable type of transmitters and receivers. In certain embodiments, the one or more transmitters 430 and/or the one or more receivers 435 may share transceiver hardware and/or circuitry. For example, the one or more transmitters 430 and/or the one or more receivers 435 may share antenna(s), antenna tuner(s), amplifier(s), filter(s), oscillator(s), mixer(s), modulator/demodulator(s), power supply, and the like.

In various embodiments, one or more transmitters 430 and/or one or more receivers 435 may be implemented and/or integrated into a single hardware component, such as a multi-transceiver chip, a system-on-a-chip, an application-specific integrated circuit (“ASIC”), or other type of hardware component. In certain embodiments, one or more transmitters 430 and/or one or more receivers 435 may be implemented and/or integrated into a multi-chip module. In some embodiments, other components such as the network interface 440 or other hardware components/circuits may be integrated with any number of transmitters 430 and/or receivers 435 into a single chip. In such embodiment, the transmitters 430 and receivers 435 may be logically configured as a transceiver 425 that uses one more common control signals or as modular transmitters 430 and receivers 435 implemented in the same hardware chip or in a multi-chip module. In certain embodiments, the transceiver 425 may implement a 3GPP modem (e.g., for communicating via NR or LTE access networks) and a non-3GPP modem (e.g., for communicating via Wi-Fi or other non-3GPP access networks).

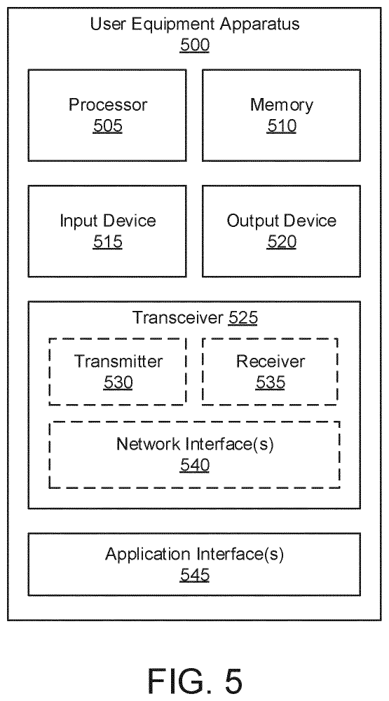

FIG. 5 depicts one embodiment of a network equipment apparatus 500 that may be used for selecting a data connection based on digital certificate information, according to embodiments of the disclosure. In some embodiments, the network equipment apparatus 500 may implement a network function, such as UPF, AMF, SMF, PCF, and/or UDM/UDR. Furthermore, network equipment apparatus 500 may include a processor 505, a memory 510, an input device 515, an output device 520, a transceiver 525. In some embodiments, the input device 515 and the output device 520 are combined into a single device, such as a touch screen. In certain embodiments, the network equipment apparatus 500 does not include any input device 515 and/or output device 520.

As depicted, the transceiver 525 includes at least one transmitter 530 and at least one receiver 535. Here, the transceiver 525 communicates with one or more remote units 105. Additionally, the transceiver 525 may support at least one network interface 540. In some embodiments, the transceiver 525 supports a first interface for communicating with a RAN node, a second interface for communicating with one or more network functions in a mobile core network (e.g., a 5GC) and a third interface for communicating with a remote unit (e.g., UE).

The processor 505, in one embodiment, may include any known controller capable of executing computer-readable instructions and/or capable of performing logical operations. For example, the processor 505 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 505 executes instructions stored in the memory 510 to perform the methods and routines described herein. The processor 505 is communicatively coupled to the memory 510, the input device 515, the output device 520, and the first transceiver 525.

In various embodiments, the network equipment apparatus 500 acquires digital certificate information for one or more applications and creates URSP rules that contain digital certificate information. In some embodiments, the processor 505 parses an application package to extract a digital certificate. The processor 505 may then generate digital certificate information, e.g., by applying a hash function to the contents of the digital certificate to form a certificate fingerprint. In other embodiments, the processor 505 receives digital certificate information from a publisher of the application, e.g., via an application interface 545. Note that the processor 505 may create URSP rules that contain digital certificate information by modifying one or more existing URSP rules to include the digital certificate information in the traffic descriptor portion(s).

The memory 510, in one embodiment, is a computer readable storage medium. In some embodiments, the memory 510 includes volatile computer storage media. For example, the memory 510 may include a RAM, including dynamic RAM (“DRAM”), synchronous dynamic RAM (“SDRAM”), and/or static RAM (“SRAM”). In some embodiments, the memory 510 includes non-volatile computer storage media. For example, the memory 510 may include a hard disk drive, a flash memory, or any other suitable non-volatile computer storage device. In some embodiments, the memory 510 includes both volatile and non-volatile computer storage media. In some embodiments, the memory 510 stores data relating to selecting a data connection based on digital certificate information, for example storing digital certificate information, URSP rules, and the like. In certain embodiments, the memory 510 also stores program code and related data, such as an operating system (“OS”) or other controller algorithms operating on the network equipment apparatus 500 and one or more software applications.

The input device 515, in one embodiment, may include any known computer input device including a touch panel, a button, a keyboard, a stylus, a microphone, or the like. In some embodiments, the input device 515 may be integrated with the output device 520, for example, as a touchscreen or similar touch-sensitive display. In some embodiments, the input device 515 includes a touchscreen such that text may be input using a virtual keyboard displayed on the touchscreen and/or by handwriting on the touchscreen. In some embodiments, the input device 515 includes two or more different devices, such as a keyboard and a touch panel.

The output device 520, in one embodiment, may include any known electronically controllable display or display device. The output device 520 may be designed to output visual, audible, and/or haptic signals. In some embodiments, the output device 520 includes an electronic display capable of outputting visual data to a user. For example, the output device 520 may include, but is not limited to, an LCD display, an LED display, an OLED display, a projector, or similar display device capable of outputting images, text, or the like to a user. As another, non-limiting, example, the output device 520 may include a wearable display such as a smart watch, smart glasses, a heads-up display, or the like. Further, the output device 520 may be a component of a smart phone, a personal digital assistant, a television, a table computer, a notebook (laptop) computer, a personal computer, a vehicle dashboard, or the like.

In certain embodiments, the output device 520 includes one or more speakers for producing sound. For example, the output device 520 may produce an audible alert or notification (e.g., a beep or chime). In some embodiments, the output device 520 includes one or more haptic devices for producing vibrations, motion, or other haptic feedback. In some embodiments, all or portions of the output device 520 may be integrated with the input device 515. For example, the input device 515 and output device 520 may form a touchscreen or similar touch-sensitive display. In other embodiments, all or portions of the output device 520 may be located near the input device 515.

As discussed above, the transceiver 525 may communicate with one or more remote units and/or with one or more interworking functions that provide access to one or more PLMNs. The transceiver 525 may also communicate with one or more network functions (e.g., in the mobile core network 140). The transceiver 525 operates under the control of the processor 505 to transmit messages, data, and other signals and also to receive messages, data, and other signals. For example, the processor 505 may selectively activate the transceiver (or portions thereof) at particular times in order to send and receive messages.

The transceiver 525 may include one or more transmitters 530 and one or more receivers 535. In certain embodiments, the one or more transmitters 530 and/or the one or more receivers 535 may share transceiver hardware and/or circuitry. For example, the one or more transmitters 530 and/or the one or more receivers 535 may share antenna(s), antenna tuner(s), amplifier(s), filter(s), oscillator(s), mixer(s), modulator/demodulator(s), power supply, and the like. In one embodiment, the transceiver 525 implements multiple logical transceivers using different communication protocols or protocol stacks, while using common physical hardware.

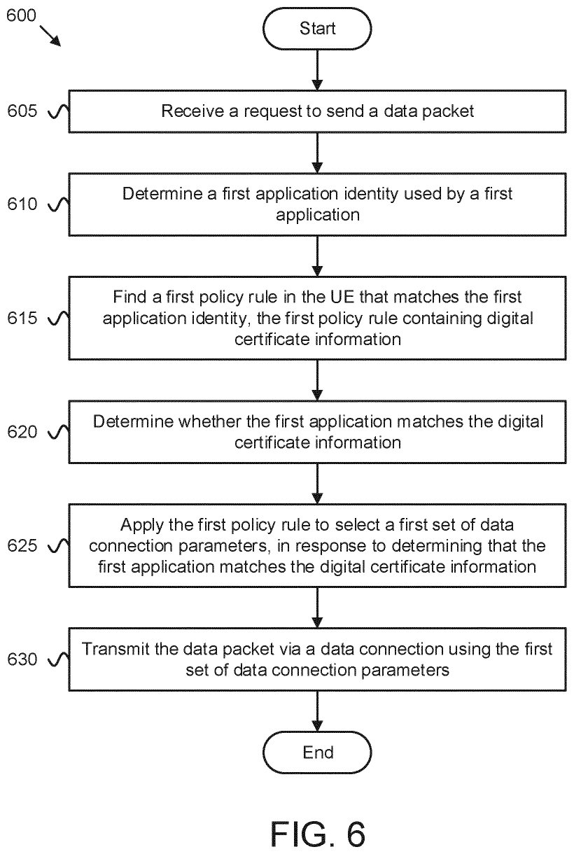

FIG. 6 depicts one embodiment of a method 600 for selecting a data connection based on digital certificate information, according to embodiments of the disclosure. In various embodiments, the method 600 is performed by a UE, such as the remote unit 105, the UE 205, and/or the user equipment apparatus 400, described above. In some embodiments, the method 600 is performed by a processor, such as a microcontroller, a microprocessor, a CPU, a GPU, an auxiliary processing unit, a FPGA, or the like.

The method 600 begins and receives 605 a request to send a data packet. The method 600 includes determining 610 a first application identity used by a first application. The method 600 includes finding 615 a first policy rule in the UE that matches the first application identity, the first policy rule containing digital certificate information. The method 600 includes determining 620 whether the first application matches the digital certificate information. The method 600 includes applying 625 the first policy rule to select a first set of data connection parameters, in response to determining that the first application matches the digital certificate information. The method 600 includes transmitting 630 the data packet via a data connection using the first set of data connection parameters. The method 600 ends.

Disclosed herein is a first apparatus for selecting a data connection based on digital certificate information, according to embodiments of the disclosure. The first apparatus may be implemented by a UE, such as the remote unit 105, the UE 205, and/or the user equipment apparatus 400. The first apparatus includes a transceiver that communicates with a mobile communication network supporting a plurality of data connections (i.e., PDU Sessions). Here, each data connection utilizes a set of data connection parameters (e.g., Access Type, DNN, S-NSSAI, SSC type, IP type, etc.).

The first apparatus includes a processor that receives a request (i.e., an internal request from an application running on the UE) to send a data packet and determines a first application identity used by a first application. The processor finds a first policy rule in the UE that matches the first application identity, the first policy rule containing digital certificate information and determines whether the first application matches the digital certificate information. Upon determining that the first application matches the digital certificate information, the processor applies the first policy rule to select a first set of data connection parameters and transmits the data packet via a data connection using the first set of data connection parameters.

In some embodiments, the processor determines the first application identity by determining an identity of the application that sent the request. In some embodiments, the UE is configured with a plurality of policy rules by the mobile communication network. In some embodiments, the UE contains a SIM (e.g., USIM) that contains a plurality of policy rules. In some embodiments, the policy rule is a URSP rule.

In some embodiments, the first policy rule matches the first application identity when the traffic descriptor of the first policy rule contains an application identity equal to the first application identity. In some embodiments, the first policy rule contains a traffic descriptor component comprising an application identity and the digital certificate information.

In some embodiments, the digital certificate information contains information (e.g., a certificate fingerprint) that uniquely identifies a digital certificate. In such embodiments, the information that uniquely identifies a digital certificate consists of a fingerprint value and a hash function utilized to generate the fingerprint value. In some embodiments, the digital certificate information contains information that identifies a publisher of the first application.

In some embodiments, the first application matches the digital certificate information if the digital certificate information in a traffic descriptor component of the first policy rule identifies a first digital certificate, where the first digital certificate is the certificate with which the first application is signed. In some embodiments, the first application matches the digital certificate information if the digital certificate information in a traffic descriptor component of the first policy rule contains information that is included in the first digital certificate, where the first digital certificate is the certificate with which the first application is signed.

In some embodiments, the processor applies the first policy rule by selecting a set of data connection parameters contained in a route selection descriptor in this rule and applying these data connection parameters to transmit the data packet. In such embodiments, the processor may determine whether a data connection that utilizes the first set of data connection parameters is already activated in the UE. If not already activated in the UE, the processor activates a data connection that utilizes the first set of data connection parameters. The processor controls the transceiver to transmit the data packet via the activated data connection.

Disclosed herein is a first method for selecting a data connection based on digital certificate information, according to embodiments of the disclosure. The first method may be performed by a UE, such as the remote unit 105, the UE 205, and/or the user equipment apparatus 400. The first method includes receiving a request to send a data packet (i.e., an internal request from an application running on the UE) and determining a first application identity used by a first application. The first method includes finding a first policy rule in the UE that matches the first application identity, the first policy rule containing digital certificate information, and determining whether the first application matches the digital certificate information. The first method includes applying the first policy rule to select a first set of data connection parameters, in response to determining that the first application matches the digital certificate information and transmitting the data packet via a data connection (i.e., PDU Session) using the first set of data connection parameters (e.g., Access Type, DNN, S-NSSAI, SSC type, IP type, etc.).

In some embodiments, determining the first application identity includes determining an identity of the application that sent the request. In some embodiments, the UE is configured with a plurality of policy rules by the mobile communication network. In some embodiments, the UE contains a SIM (e.g., USIM) that contains a plurality of policy rules. In some embodiments, the policy rule is a URSP rule.

In some embodiments, the first policy rule matches the first application identity when the traffic descriptor of the first policy rule contains an application identity equal to the first application identity. In some embodiments, the first policy rule contains a traffic descriptor component comprising an application identity and the digital certificate information.

In some embodiments, the digital certificate information contains information (e.g., a certificate fingerprint) that uniquely identifies a digital certificate. In such embodiments, the information that uniquely identifies a digital certificate consists of a fingerprint value and a hash function utilized to generate the fingerprint value. In some embodiments, the digital certificate information contains information that identifies a publisher of the first application.

In some embodiments, the first application matches the digital certificate information if the digital certificate information in a traffic descriptor component of the first policy rule identifies a first digital certificate, where the first digital certificate is the certificate with which the first application is signed. In some embodiments, the first application matches the digital certificate information if the digital certificate information in a traffic descriptor component of the first policy rule contains information that is included in the first digital certificate, where the first digital certificate is the certificate with which the first application is signed.

In some embodiments, applying the first policy rule includes selecting a set of data connection parameters contained in a route selection descriptor in this rule and applying these data connection parameters to transmit the data packet. In such embodiments, the first method may include determining whether a data connection that utilizes the first set of data connection parameters is already activated in the UE. If not already activated in the UE, the first method includes activating a data connection that utilizes the first set of data connection parameters. The first method includes transmitting the data packet via the activated data connection.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method of a user equipment (“UE”), the method comprising:
receiving a request to send a data packet;
determining a first application identity used by a first application;
finding a first policy rule in the UE that matches the first application identity, the first policy rule containing digital certificate information;
determining whether the first application matches the digital certificate information;
applying the first policy rule to select a first set of data connection parameters, in response to determining that the first application matches the digital certificate information; and
transmitting the data packet via a data connection using the first set of data connection parameters.

2. The method of claim 1, wherein determining the first application identity comprises determining an identity of the application that sent the request.

3. The method of claim 1, wherein the first policy rule matches the first application identity when the traffic descriptor of the first policy rule contains an application identity equal to the first application identity.

4. The method of claim 1, wherein the first policy rule contains a traffic descriptor component comprising an application identity and the digital certificate information.

5. The method of claim 1, wherein the UE is configured with a plurality of policy rules by the mobile communication network.

6. The method of claim 1, wherein the UE contains a subscriber identity module (“SIM”) that contains a plurality of policy rules.

7. The method of claim 1, wherein the policy rule is a UE Route Selection Policy (“URSP”) rule.

8. The method of claim 1, wherein the digital certificate information contains information that uniquely identifies a digital certificate.

9. The method of claim 8, wherein the information that uniquely identifies a digital certificate consists of a fingerprint value and a hash function utilized to generate the fingerprint value.

10. The method of claim 1, wherein the digital certificate information contains information that identifies a publisher of an application.

11. The method of claim 1, wherein the first application matches the digital certificate information if the digital certificate information in a traffic descriptor component of the first policy rule identifies a first digital certificate, where the first digital certificate is the certificate with which the first application is signed.

12. The method of claim 1, wherein the first application matches the digital certificate information if the digital certificate information in a traffic descriptor component of the first policy rule contains information that is included in the first digital certificate, where the first digital certificate is the certificate with which the first application is signed.

13. The method of claim 1, wherein applying the first policy rule comprises selecting a set of data connection parameters contained in a route selection descriptor in this rule and applies these data connection parameters to transmit the data packet.

14. The method of claim 13, further comprising
determining whether a data connection that utilizes the first set of data connection parameters is already activated in the UE;
activating a data connection that utilizes the first set of data connection parameters if not already activated in the UE; and
transmitting the data packet via the activated data connection.

15. A user equipment (“UE”) apparatus comprising:
a transceiver that communicates with a mobile communication network supporting a plurality of data connections, each data connection utilizing a set of data connection parameters, and
a processor that:
receives a request to send a data packet;
determines a first application identity used by a first application;
finds a first policy rule in the UE that matches the first application identity, the first policy rule containing digital certificate information;
determines whether the first application matches the digital certificate information;
applies the first policy rule to select a first set of data connection parameters, in response to determining that the first application matches the digital certificate information; and
transmits the data packet via a data connection using the first set of data connection parameters.

16. The apparatus of claim 15, wherein determining the first application identity comprises determining an identity of the application that sent the request, wherein the first policy rule matches the first application identity when the traffic descriptor of the first policy rule contains an application identity equal to the first application identity.

17. The apparatus of claim 15, wherein the first policy rule is a UE Route Selection Policy (“URSP”) rule that contains a traffic descriptor component comprising an application identity and the digital certificate information.

18. The apparatus of claim 15, wherein the digital certificate information contains a certificate fingerprint value and a hash function utilized to generate the certificate fingerprint value.

19. The apparatus of claim 15, wherein the digital certificate information contains information that identifies a publisher of an application.

20. The apparatus of claim 15, wherein applying the first policy rule comprises selecting a set of data connection parameters contained in a route selection descriptor in this rule and applies these data connection parameters to transmit the data packet, wherein the processor further:
determining whether a data connection that utilizes the first set of data connection parameters is already activated in the UE;
activating a data connection that utilizes the first set of data connection parameters if not already activated in the UE; and
transmitting the data packet via the activated data connection.
